(19) United States
(12) Patent Application Publication
(10) Pub. No.: US 2007/0205899 A1
(43) Pub. Date: Sep. 6, 2007

(54) Crystal mount identification

(75) Inventors: John M. Ziegler, Spring, TX (US); Bret Simpson, Montgomery, TX (US)

Correspondence Address: R. PERRY MCCONNELL, P.C., 9001 FOREST CROSSING, SUITE F, THE WOODLANDS, TX, 77381, US

(73) Assignee: Rigaku Americas Corporation

(21) Appl. No.: 11/366,075

(22) Filed: Mar. 1, 2006

(51) Int. Cl. G08B 13/14

(52) U.S. Cl. 340/572.8; 340/572.7

(57) ABSTRACT

A crystal mount for use in a cryogenic environment which comprises an RFID transponder capable of transmitting tracking information unique to the crystal mount or the composition of a sample mounted thereon.

### FELD OF THE INVENTION

The invention pertains to the field of automated identification and tracking of crystal samples via radio frequency identification (“RFID”).

### BACKGROUND OF THE INVENTION

Crystallography applications have expanded to include mass production of crystal samples of biomolecules for use in testing new biocomponents, such as experimental drug compositions, quickly and efficiently. It is often desirable to test multiple variations of the combinations being examined. Such testing applications often require multiple test cells to be used, because some samples will not crystallize, or the crystals will be of insufficient quality to permit sufficient resolution in the crystallography. Accordingly, it is often necessary to provide a sizeable number of test cells to provide a sufficient sample that some adequate crystals form with each desired combination of materials.

Crystal mounts have been developed which provide a standardized platform for the growing of test crystals, and which are adapted to be used by automated sample handlers for more efficient testing. Because test crystals must be maintained at cryogenic temperatures, the crystal mounts and the handlers which manipulate them must be configured to operate when exposed to cryogenic temperatures. Further, the crystal mounts and other parts exposed to cryogenic temperatures must often be capable of withstanding repeated cycling between cryogenic temperatures and much warmer temperatures.

Due to the number of crystal mounts which may be in use in any one test, and due to the increased use of automated equipment to handle the crystal mounts and record data, it is desirable to have the ability to automatically identify and catalog each crystal mount. Positional indexing of samples in sample trays may be used, but is vulnerable to any failure of the handling system to return a sample to its original position. Further, positional indexing requires some comparison between the physical position of a sample and a manual or computerized index to determine the identity of a particular sample. Such comparisons are time-consuming in an industry in which the efficiency of such operations are increasingly important.

Accordingly, it is desirable to provide a sample identification system which can identify a particular crystal mount, and thus a particular crystal sample, without regard to a physically indexed location of the crystal mount. It is also desirable to provide such a system which can provide identifications quickly, and to provide the ability to place identifying detectors at convenient locations for sample tracking.

### SUMMARY OF THE INVENTION

The invention is an RFID crystal mount, comprising a radio frequency identification (“RFID”) transponder that is capable of providing a continuous identification signal attached to the crystal mount. However, use of RFID transponders requires that each mount also comprises an antenna to transmit the RFID signal to a receiver.

In a typical application, a commercially available crystal mount such as the Hampton Research CrystalCap HT™ may be modified to provide an RFID crystal mount. An RFID transponder, such as a TI ISO 15693, is preferably encased in cryo epoxy to protect the transponder and its wire connections from mechanical shock. Preferred transponders provide programmable capacity, so that the transponder may be programmed with identification information related to the sample identification and, if desired, the sample composition.

In a preferred embodiment, the crystal mount comprises a stem section, allowing a cylindrical section of Teflon tubing to be placed in slideable contact with the stem. Because the stem section of the crystal mount is generally a solid metal shaft, this Teflon tubing provides a thermo-mechanical buffer between the crystal mount stem and the RFID apparatus. The Teflon tubing additionally provides electrical isolation between the stem and the RFID apparatus. Preferably, the Teflon tube has an ID sized to provide close contact with the stem, so that the Teflon tube will not slide out of position once it is in place.

In a preferred embodiment, a cylindrical ferritic shield, such as a Fair-Rite Products #2643000301 Shield Bead, is positioned around and in mechanical contact with the Teflon tubing. On the outside of the ferritic shield, a helically-wound antenna, comprised for example of 0.005″ enameled copper wire, is formed. This antenna is connected to an RFID transponder via an antenna lead.

As those of skill in the art will recognize, if a Teflon tube is used to provide mechanical attachment between the stem section and the ferritic shield, the tube can be sized to and OD which provides a close-tolerance fit with the ID of the ferritic shield, providing a convenient and secure means of mounting the ferritic shield.

Either before or after the RFID crystal mount is assembled, the RFID transponder may be programmed with information identifying the particular RFID crystal mount, or identifying the composition of the crystal mounted to it.

In an alternative embodiment, the ferritic shield may be secured directly to the crystal mount with cryo epoxy or another adhesive which can tolerate cryogenic temperatures. However, the brittleness of the ferritic shield must be considered when providing such an attachment.

In another alternative embodiment, the antenna may be secured directly to the crystal mount, without the use of a ferritic shield. The ferritic shield provides a benefit in reducing potential interference between the antenna and the metal in the crystal mount. Those of skill in the art will recognize, however, that such potential interference may be tolerated in some applications without departing from the spirit of the invention.

### BRIEF DESCRIPTION OF THE DRAWINGS

FIG. 1 is a cross-sectional view of one embodiment of the invention.

FIG. 2 is a cross-sectional view of another embodiment of the invention.

FIG. 3 is a schematic diagram of a method of operation of the invention.

### DETAILED DESCRIPTION

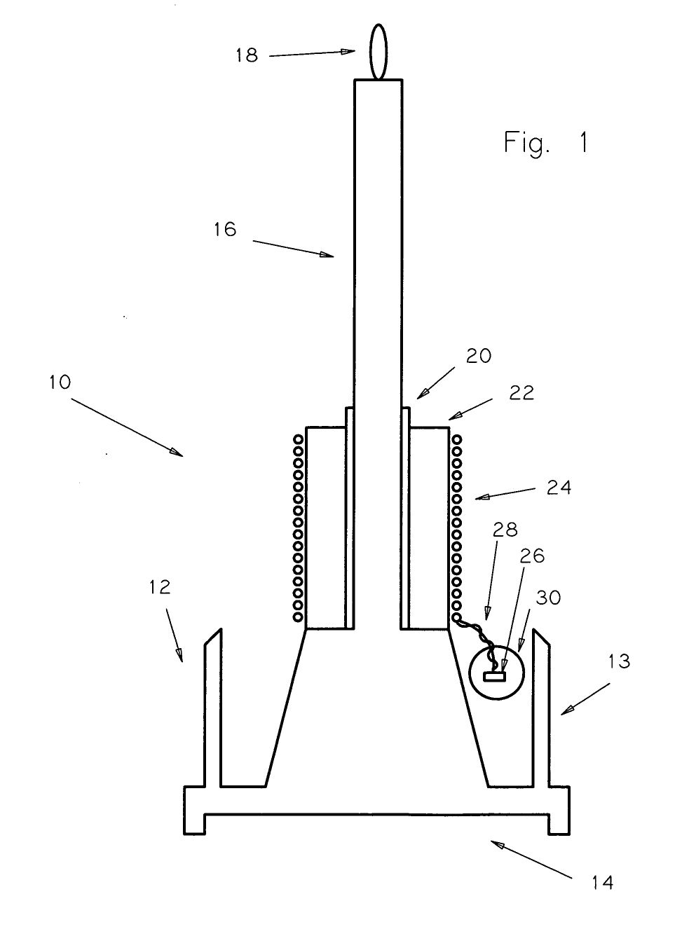

Referring to FIG. 1, an embodiment of the present invention is shown in cross-section. An RFID crystal mount 10 comprises a base 12, which in turn comprises a stem 16, and crystal holder 18. A base well 14 provides a connector bore for retaining magnets to hold the RFID crystal mount 10, for example, when it is in a magazine (not shown) or on a goniometer (not shown). Relief area 13 provides a gripping point for a manipulator arm (not shown) to grasp the RFID crystal mount 10 to move it.

A Teflon tube 20 is closely fitted around the stem 16, and provides thermo-mechani-cal and electrical isolation between the stem 16 and a ferritic shield 22. Preferably, the Teflon tube 20 is fitted in close tolerance to the ferritic shield 22 to provide a secure mounting for the ferritic shield 22. In an alternative embodiment, the Teflon tube 20 may be omitted, or replace by cryo epoxy (not shown) or an alternative adhesive which can tolerate cryogenic temperatures.

An antenna 24 is wound around the outside of the ferritic shield 22, and is in signal communication with an RFID transponder 26 via antenna lead 28. Antenna 24 may be helically-wound, or wound in another fashion to provide adequate reception of the signal from the RFID transponder 26. Preferably, the RFID transponder 26 is encased in cryo epoxy 30 to protect the RFID transponder 26 and its connections from mechanical shock.

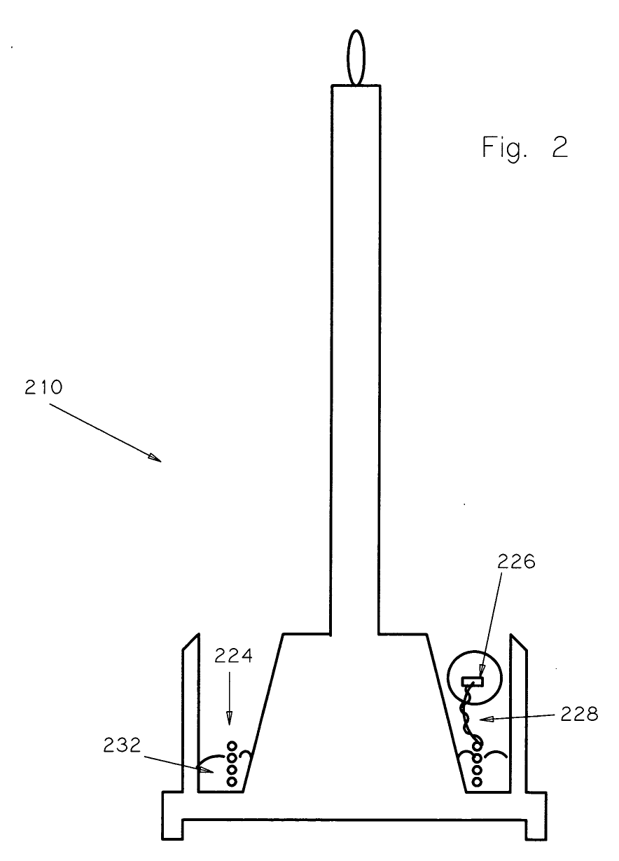

Referring to FIG. 2, in an alternative embodiment, an antenna 224 may be directly attached to the RFID crystal mount 210 by cryo epoxy 232 or some other non-conductive adhesive which can tolerate cryogenic temperatures. As in the previous embodiment, antenna 224 is in signal communication with RFID transponder 226 via antenna lead 228.

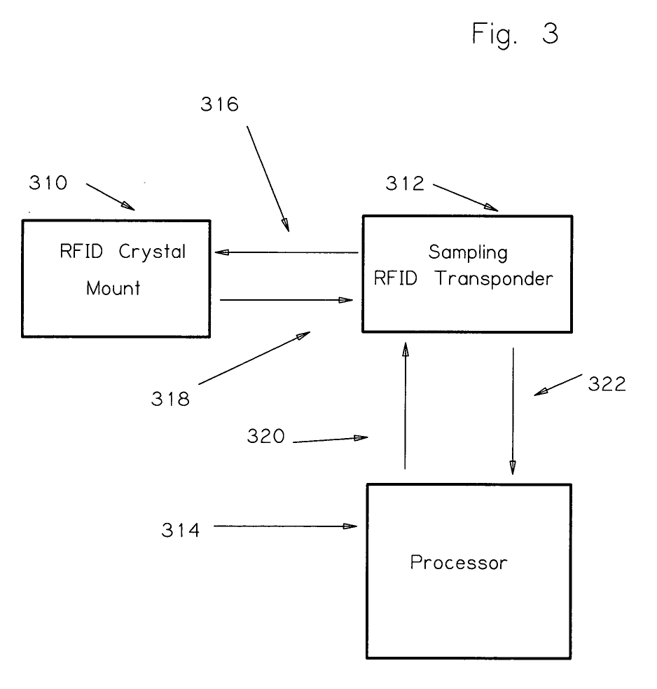

Referring to FIG. 3, a method of operation of the invention is shown schematically. When interrogated by a sampling RFID transponder 312, the RFID crystal mount 310 transmits signals 318 to the sampling RFID transponder 312. A processor 314, such as a computer, tracks RFID crystal mount 310 by receiving signals 322 from sampling RFID transponder 312. Processor 314 may also send instructions 320 to sampling RFID transponder 312 to transmit information 316 to RFID crystal mount 310. In this way, the content of signals 318 from the RFID crystal mount 310 may be programmed to include information unique to the RFID crystal mount 310, such as a unique identifying code or information regarding the content of the sample currently mounted on the RFID crystal mount 310. Such programming may optionally be performed either before or after a crystal is mounted to RFID crystal mount 310.

The above examples are included for demonstration purposes only and not as limitations on the scope of the invention. Other variations in the construction of the invention may be made without departing from the spirit of the invention, and those of skill in the art will recognize that these descriptions are provide by way of example only.

We claim:

1. A trackable crystal mount for use in cryogenic environments, comprising
a base,
an antenna mechanically coupled to said base, and
an RFID transponder in signal communication with said antenna.

2. The trackable crystal mount of claim 1, additionally comprising
a ferritic shield between said base and said antenna, wherein said ferritic shield is mechanically coupled to said base.

3. The trackable crystal mount of claim 1, additionally comprising
a thermo-mechanical shield between said base and said antenna, wherein said thermo-mechanical shield is mechanically coupled to said base.

4. The trackable crystal mount of claim 1, wherein said antenna is electrically isolated from said base.

5. The trackable crystal mount of claim 2, wherein said ferritic shield is electrically isolated from said base.

6. The trackable crystal mount of claim 3, wherein said thermo-mechanical shield comprises a Teflon shield.

7. The trackable crystal mount of claim 1, wherein said RFID transponder is protectively encased.

8. The trackable crystal mount of claim 1, wherein said RFID transponder is protectively encased in cryo epoxy.

9. A method of tracking a crystal mount in a cryogenic environment, comprising the steps of
creating an RFID signal unique to said crystal mount with an RFID transponder,
broadcasting said RFID signal from said crystal mount,
receiving said RFID signal, and
processing said RFID signal to maintain information related to said crystal mount.

10. The method of tracking of claim 9, additionally comprising the steps of
programming said RFID transponder to include information unique to said crystal mount in said RFID signal.

11. The method of tracking of claim 9, additionally comprising the steps of
programming said RFID transponder to include information unique to a sample mounted on said crystal mount in said RFID signal.
